(19) United States
(12) Patent Application Publication
(10) Pub. No.: US 2023/0331929 A1
(43) Pub. Date: Oct. 19, 2023

(54) Functional colloidal lignin particles and methods of preparation thereof

(71) Applicant: Aalto University Foundation sr, Aalto (FI)

(72) Inventors: Kalle Lintinen, Espoo (FI); Mauri Kostiainen, Espoo (FI); Alexander Fusi, Espoo (FI)

(21) Appl. No.: 18/020,642

(22) PCT Filed: Aug. 16, 2021
(86) PCT No.: PCT/FI2021/050552

§ 371 Date: Feb. 15, 2023

(30) Foreign Application Priority Data
Aug. 16, 2020 (FI) 20205800

(51) Int. Cl. C08H 7/00; C08J 3/07; C08J 3/24; B29C 71/02; C08K 5/07; C09J 197/00

(52) U.S. Cl. CPC C08H 6/00; C08J 3/07; C08J 3/24; C08J 7/08; C08K 5/07; C09J 197/005; C08J 2397/00

(57) ABSTRACT

Method of forming functionalized colloidal lignin particles, comprising the step of providing lignin in a dissolved form, aldehyde functionalizing lignin, forming a colloidal dispersion of lignin, partially removing organic solvents and heat-curing the dispersion. The concentrated colloidal dispersion is dried by spray drying. The invention can be used in applications where the functioned and colloidal nature of lignin will afford an advantage over bulk lignin.

### FIELD OF INVENTION

The present invention relates to functional colloidal lignin particles, as well as to dispersions of functional colloidal lignin particles. In particular, the present invention concerns a method of forming functional colloidal lignin particles.

The invention disclosed herein also relates to the use of functional colloidal lignin in multiple applications, especially in adhesives, coatings and in the replacement of carbon black in the manufacture of tires.

### BACKGROUND

Lignin is a major by-product of the pulp industry and is currently used mostly for fuel. The pulp and paper industry alone produces roughly 50 million tons of extracted lignin per year. While most of the produced lignin is still burned for its energy content, several higher volume applications with it are currently explored, such as binders and adhesives, carbon materials and sources of chemicals. The most significant application being in the replacement of phenol in phenol-formaldehyde adhesives. However, most of the present lignin-based phenolic resins are limited to a relatively low degree of phenol replacement. There are two major reasons for this. Firstly, lignin contains a relatively small concentration of reactive functional (phenolic) groups. Thus, even when all of these are reacted with formaldehyde, the subsequent concentration of methylol groups is far smaller than the methylol concentration in phenol-formaldehyde resin and consequently phenol-free lignin-formaldehyde resins cannot cure into an extended polymer network in the conditions usually used for wood adhesives. Secondly, the viscosity of lignin-phenol-formaldehyde resins is higher than that of phenol-formaldehyde adhesives with the same solid content, with higher phenol replacement corresponding with higher viscosities. To obtain a desirable viscosity, the degree of phenol replacement traditionally has to have been kept relatively low. Thus far, no lignin-based adhesive has been produced, which could replace the majority of phenol in phenol-formaldehyde adhesives, and still possess similar properties as the phenol-formaldehyde (PF) reference. In view of the drawbacks with prior art in producing a lignin-based adhesive with high phenol replacement rate and with adhesive properties matching PF resins, there is a continued need to develop lignin-based adhesives that can match or surpass the cost and properties of PF adhesives.

There has already been also some research about using colloidal lignin particles in obtaining improved adhesive performance. As regards the state-of-the-art, reference is made to International patent specifications WO2015/089456 and WO 2018/011668. However, colloidal lignin particles are not any more reactive than the lignin it is made of. The challenge in using colloidal lignin particles with, for example, phenol-formaldehyde chemistry is that such reactions require such alkaline conditions that colloidal lignin particles are dissolved in these conditions. Thus, means to render colloidal lignin particles stable in various pH and solution environments is required. While the primary application for such stable functionalized colloidal lignin particles is the replacement of phenolic resins, they are by no means limited to them. There are various applications to be exploited.

### SUMMARY OF THE INVENTION

It is an object of the present invention to provide a stable aqueous dispersion of aldehyde functionalized spherical colloidal lignin particles.

Especially, it is an object of the present invention to provide a method that produces stable functionalized spherical colloidal lignin particles, especially functionalized solvent-embedded colloidal lignin particles. Thus, one aim is to obtain pH and solvent stable colloidal lignin particles for multiple applications.

The present invention is at least partially based on the idea of making colloidal lignin particles pH and solvent stable by cross-linking the colloidal lignin particles. Cross-linking of the particles requires functionalization of lignin to provide functional groups being able to react with each other. The present invention provides a method of forming both externally and internally homogeneous colloidal lignin particles, wherein the particles are uniformly reactive and cross-linking may occur properly, wherein extremely stable colloidal lignin particles are obtained. While the spherical shape of lignin particles is an important factor for curing, they generally do not cure well if the internal morphology of the colloidal spheres is not homogenous.

Further, the present invention is at least partially based on the idea of making colloidal lignin particles pH and solvent stable by rearranging the lignin nanotubes of the colloidal lignin particles to be better interleaved with each other during curing in the presence of organic solvent and sufficiently high temperature.

In an embodiment of the method of the present invention for forming an aqueous dispersion of aldehyde functionalized spherical colloidal lignin particles, lignin is first provided in a dissolved form, wherein it can be functionalized by reacting with aldehyde. The functionalized lignin is mixed with water and at least two organic solvents to form colloidal lignin particle dispersion by self-assembly of lignin. Next, organic solvents are partially removed from the dispersion and the remaining dispersion is preferably cured, in particular heat-cured, i.e. cross-linked or at least rearranged, in the presence of at least some organic solvent until the colloidal lignin particles are stable.

The presence of organic solvent during curing enables internally homogeneous colloids, wherein cross-linking or rearrangement of the particles can be fully completed, i.e. the colloids can be controllably cured.

Thus, it is one object of the present invention to provide a method that provides solvent-embedded colloidal lignin particles.

Further, it has been found that functionalized cross-linked spherical colloidal lignin particles can be formed in a simple method which for example eliminate some intermediate steps known in the art. Basically, the present invention is based on the finding that aldehyde functionalized lignin can be directly self-assembled into colloidal lignin particles in a mixture of acidic water and at least two organic solvents without a separate neutralization and washing steps.

Thus, according to one embodiment, the method of the present invention comprises providing lignin in an alkaline, i.e. dissolved, form, wherein it can be functionalized by reacting with aldehyde, directly after which colloidal lignin particles are formed in a mixture of acidic water and two organic solvents. The modification of lignin prior to colloid formation enables cross-linking of lignin molecules within colloidal lignin particles in the dispersion by forming covalent bridges with the functional groups. Examples of such bridges being methylene bridge when formaldehyde is used and glyoxyl bridge when glyoxal is used. Thus, the present invention discloses formation of spherical colloidal lignin particles with embedded solvent and water, which colloids are functionalized, wherein the colloids can be cross-linked to render them pH and solvent stable. Further, fully cross-linked colloidal lignin particles retain their spherical structure also at high pH and in different solvent environments. Such fully cross-linked structures are slightly swollen due to the solvent embedded in the colloids. The swollen lignin colloids can be compressed together to either form fully fused structures or partially merged spheres that can be cured into place, enabling many applications, such as adhesives and coatings.

More specifically, the present invention is characterized by what is stated in the independent claims.

The present invention achieves considerable advantages.

It has surprisingly been found in the present invention, that the presence of organic solution, especially ethanol, in the aqueous dispersion of colloidal lignin particles during heat-curing is advantageous for proper cross-linking of the functionalized colloidal lignin particles. Typically, organic solvents are evaporated from the dispersion after colloid formation in order to provide a solvent free dispersion and to recycle the solvents. When at least a small amount of organic solvent is left in the colloidal lignin dispersion, the cross-linking of the colloidal lignin particles can be conducted controllably without further adjustment of pH.

While the use of organic solvent aids in the cross-linking of colloidal lignin particles at a wider pH range, lignin colloid formed at a low pH (at or lower than 3.96) can still be cross-linked without controlling the amount of organic solvent (i.e. basically without it). However, cross-linking at a higher pH without organic solvent does not occur or at least is not complete. The difference, but this is merely one alternative and the interpretation is not limiting for the present invention, can probably be attributed to the internal morphology of the formed colloidal lignin particles. At pH 3.96, or lower, carboxylic acid groups of lignin are sufficiently undissociated for lignin to be self-soluble, making colloids internally homogeneous. By contrast, at a higher pH sufficiently many carboxylic acid groups are present as sodium carboxylates, resulting in internal phase separation within the colloids, which in turn both hinders the cross-linking of methylolated colloids and hinders the solvent recovery of all lignin colloids as the evaporation of a colloidal lignin particle dispersion prepared at such pH causes foaming.

Further, functionalized spherical colloidal lignin particles represent a valuable asset for the valorization of lignin side-streams from the pulp industry. The colloidal structure allows for the circumvention of the heterogeneous and poorly dispersible structure of the biopolymer, since when forming colloidal lignin particles, the inherently heterogeneous lignin is made homogeneous. Thus, stable aldehyde functionalized colloidal lignin particles can be efficiently produced, especially in the present invention which provides cross-linked spherical colloidal lignin particles. Especially, the present invention provides homogeneous and stable colloidal lignin particles in a wide range of pH and solution environments. Further, lignin of the present invention can be dissolved into an organic solvent or a solvent mixture at a high concentration.

In addition, by using a solvent having a lower boiling point than water, efficient solvent recovery can be achieved by distillation. By contrast, the recovery of a solvent with a high boiling point by evaporation is not economically feasible. Also, lignin certainly provides less expensive and greener options for current materials.

Next, embodiments will be examined more closely with the aid of a detailed description with reference to the appended drawings.

### BRIEF DESCRIPTION OF THE DRAWINGS

FIG. 1 shows the Schematic presentation of one embodiment of lignin cross-linking comprising the following steps: glyoxylation of an organic lignin solution (i), the formation of CLPs upon the introduction of the organic lignin solution to water (ii), partial removal of organic solvents by rotary evaporation (iii) and cross-linking of the CLPs by gradual evaporation of the organic solvents (iv).

FIG. 2 shows the general method of analyzing the aldehyde consumption of the alkaline lignin solution by dilution, acid precipitation, centrifugation and analysis of the supernatant.

FIG. 3 shows the effect of curing time of CLPs on the PDI of CLPs dispersed in 20 mM NaOH. Three colors show three replications of the same experiment, with good DLS quality obtained in each experiment after 75 min curing.

FIG. 4 shows the transmission electron microscopy (TEM) image of cured CLPs from Example 5 at pH 11.72.

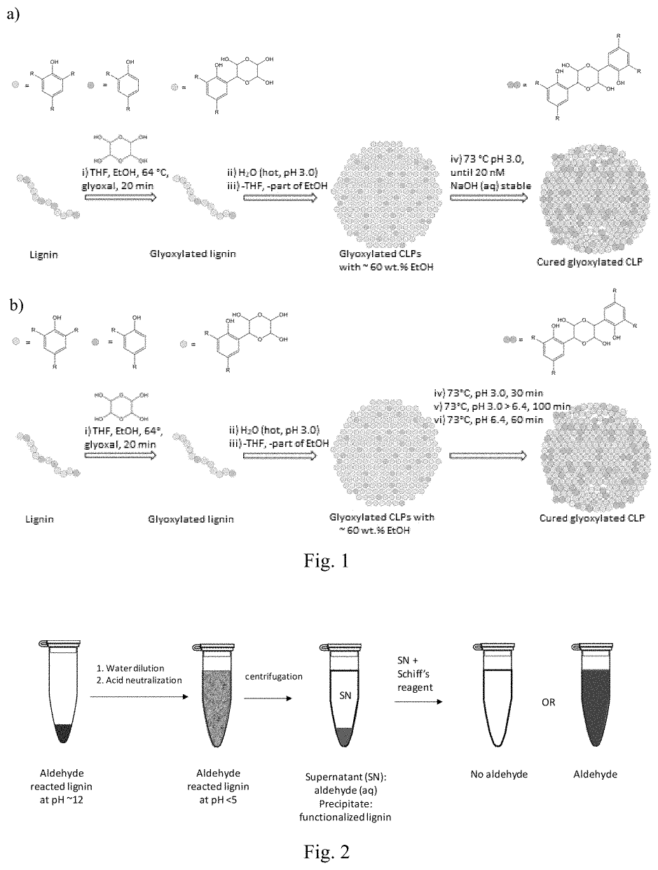

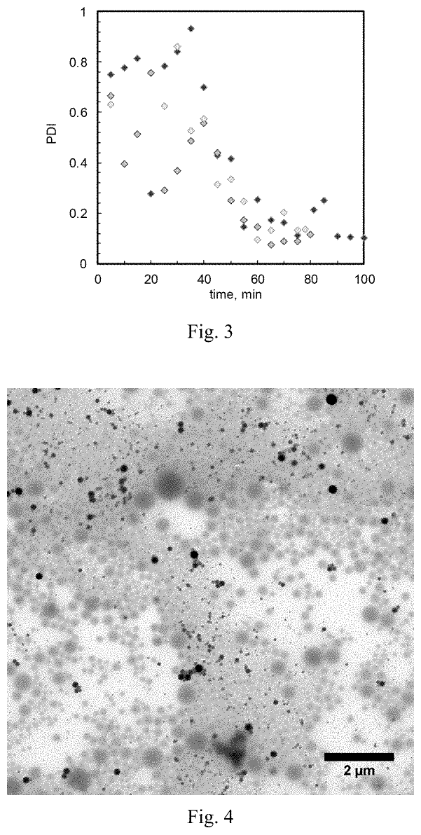

### DETAILED DESCRIPTION OF EMBODIMENTS

Herein, the term colloidal lignin particle (CLP; plural, CLPs) refers to lignin material that does not sediment in a fluid upon holding still for at least two hours. Moreover, CLPs can be passed through a filter membrane with a particle retention value of less than 15 micrometers, preferably less than 2 micrometers, in particular less than 1 micrometer. The term lignin nanoparticle is used as a synonym to CLP.

Unless otherwise stated, properties that have been experimentally measured or determined herein have been measured or determined at room temperature. Unless otherwise indicated, room temperature is 25° C.

Unless otherwise stated, properties that have been experimentally measured or determined herein have been measured or determined at atmospheric pressure.

It must also be noted that, as used in the specification and the appended claims, the singular forms “a,” “an” and “the” include plural referents unless otherwise specified.

As used herein, the term “about” refers to a value which is ±5% of the stated value.

As used herein, the term “about” refers to the actual given value, and also to an approximation to such given value that would reasonably be inferred to one of ordinary skill in the art, including approximations due to the experimental and/or measurement conditions for such given value.

As used herein, the term “average particle size” refers to the number average particle size based on a largest linear dimension of the particles (also referred to as “diameter”) as determined using a technique known to those skilled in the art such as Light Scattering technique.

As used herein, the term “average particle size” refers to the D₅₀ value of the cumulative volume distribution curve at which 50% by volume of the particles have a diameter less than that value.

The present invention concerns an aqueous dispersion of aldehyde functionalized spherical colloidal lignin particles. According to one embodiment, spherical particle refers to a particle that exhibit a rotational symmetrical shape akin to that of spheres, i.e. spherical particle has a form like a sphere in being round, or more or less round, in three dimensions.

Further, the present invention concerns aldehyde functionalized solvent-embedded colloidal lignin particles. Especially, the present invention concerns a method for producing such colloidal lignin particle dispersion. In the method, lignin is preferably functionalized prior to the formation of colloidal lignin particles.

According to one embodiment the term “fully cross-linked” in the present invention means that at least 90%, preferably at least 95%, more preferably at least 99%, most preferably 100% of the reactive groups (methyl groups) of the lignin are reacted to form covalent bridges between lignin particles.

In one embodiment, the method of the present invention comprises
providing lignin in a dissolved form,
functionalizing lignin by reacting it with aldehyde,
providing the functionalized lignin in a mixture with water and at least two organic solvents to form spherical colloidal lignin particle dispersion,
partially removing organic solvents from the dispersion, and
heat-curing the dispersion until the particles are stable.

In one embodiment, in the present invention lignin is functionalized by reacting with an aldehyde. In order to react lignin with aldehyde, lignin needs to be in a dissolved form, i.e. in alkaline form, i.e. in sodium carboxylate/phenolate form, wherein lignin preferably comprises at minimum, equimolar amount of NaOH and acidic OH. The lignin used can be in a dissolved form as such, or it can be dissolved by using an appropriate solvent. Thus, in a first step of the present method lignin is preferably provided in a dissolved form.

According to a preferred embodiment, types of lignin suitable for the process are any lignin soluble at concentrations of at least 5 wt. %, preferably at concentrations of 10 wt. % or more in at least one organic solvent, when sodium-free. Such lignin is for example softwood kraft lignin, hardwood kraft lignin and plant lignin.

According to one embodiment, lignin is obtained from a lignocellulosic raw-material by dissolution in an alkaline medium or in an organic medium. In particular the lignin is isolated from black liquor of pulping of a lignocellulosic raw-material. Further, lignin can be obtained from black liquor by precipitation and by separation of the precipitated lignin. Black liquor is especially preferably source of lignin in the present invention since black liquor is readily present as sodium carboxylate/phenolate, i.e. in dissolved form, wherein it can be straight away reacted with aldehyde without any dissolution steps.

According to embodiment, a LignoBoost lignin is used. Such lignin can be obtained from black liquor which is obtained from evaporation and whose pH is lowered with CO₂. The precipitated lignin is dewatered with a filter press. The lignin is then preferably redissolved in spent wash water and acid. The resulting slurry is once again dewatered and washed, with acidified wash water, to produce cakes of lignin, virtually pure. The lean liquor is for example returned to the liquor cycle.

According to one embodiment lignin can be dissolved by using organic solution, especially a mixture of at least two organic solvents. Examples of the organic solvents for the dissolution of lignin are any organic solvents miscible in water and capable of dissolving at least one type of lignin at concentrations of at least 5 wt. %, preferably at concentration of 10 wt. % or more, are tetrahydrofuran and others, such as ethanol, dimethyl sulfoxide, acetic acid and dioxane.

According to a preferred embodiment, the organic solution includes an organic solvent and a co-solvent. The ratio of solvent and co-solvent can be adjusted to maximize the concentration of colloidal lignin particles in the final dispersion. While lignin is extremely soluble in some organic solvents, such as tetrahydrofuran (THF), the addition of a concentrated organic solvent solution of lignin into water will result in the fusing of the forming colloidal lignin particles into aggregates. When a fraction of, for example, THF solvent is replaced with a co-solvent, such as but not limited to ethanol, the concentration of lignin can be raised considerably without the aggregation of the forming colloidal particles.

According to one embodiment, the ratio of solvent and co-solvent is in the range of 1:3-3:1, preferably the ratio is about 1:1.

According to one embodiment, the organic solvent is cyclic ether, such as tetrahydrofuran.

The used co-solvent can be any solvent miscible in water and capable of suppressing aggregation of lignin colloids at high lignin concentrations. Short to medium chained alcohols are known to be efficient co-solvents in prior art. Specifically the use of ethanol is preferred due to its low price and safety. Methanol works efficiently as well and can easily be recovered. Examples of other such solvents are n-propanol, isopropanol, n-butanol, isobutanol and tert-butanol.

According to preferred embodiment, the co-solvent is short to medium chained alcohol, i.e. selected from the group of alcohols containing 1 to 10, in particular 1 to 6, for example 1 to 4 carbon atoms. Such alcohols are for example ethanol and methanol.

In preferred embodiment, the mixture of organic solvents consists of tetrahydrofuran together with ethanol or methanol or together with a combination of ethanol and methanol.

Numerous other variations and modifications in the invention as illustrated in the specific examples will be apparent to those skilled in the art, and hence it is not intended that the invention be limited to the examples but only as required by the spirit and scope of the appended claims.

The organic solution may further comprise some water, however, in an amount that is not enough to precipitate colloidal lignin particles, in particular the amount of water is smaller than 50 wt. % of the weight of the dispersion, for example 10-40 wt. %, such as 30 wt. %.

According to another embodiment lignin can be dissolved in a basic, i.e. alkaline, aqueous solution. Typically, lignin is basified with sodium hydroxide (NaOH) and diluted with water, preferably deionized water, or straightly dissolved in a mixture of aqueous NaOH solution. The mixture is mixed until a homogeneous solution is obtained.

Thus, according to one embodiment the lignin is provided in a dissolved form by dissolving lignin into an alkaline aqueous solution, for example into the mixture of sodium hydroxide and water, or into an organic solution, preferably into a mixture of at least two organic solvents, for example tetrahydrofuran and ethanol.

After the functionalization of lignin, at least a part of the phenolic groups have chemically been modified in the ortho position. According to a preferred embodiment half of the available ortho positions phenolic groups (most notably uncondensed guaiacyl groups) have been chemically modified.

According to one embodiment, low molecular weight impurities can be removed by decanting the dissolved solution.

Next, the lignin being in a dissolved form is functionalized, i.e. reacted with an aldehyde, whereby a functionalized lignin derivative is formed. Based on the above the aldehyde functionalization can be realized in an organic solution of lignin or in a basic aqueous solution of lignin.

According to one embodiment, when lignin is functionalized in a basic aqueous solution, the obtained solution can be neutralized either with acidic water or with an acidic organic solution to yield a functionalized lignin solution, which can be used to make aqueous spherical colloidal lignin particles. Examples of acids suitable for the neutralization of alkaline lignin solution are any acids that will react with the sodium phenolate and sodium carboxylate groups of lignin. Examples of such acids are carbon dioxide, sulfuric acid, hydrogen chloride and nitric acid.

However, according to a preferred embodiment, also in the case of basic aqueous solution, functionalized lignin is straight forwarded to a colloid formation without any intermediate neutralization steps, i.e. lignin is neutralized in the mixture from which the colloidal sphere is self-assembled.

According to one embodiment the aldehyde used in the present invention can be any aldehyde that can be reacted with lignin at a temperature where no significant self-condensation of lignin occurs but which will induce self-condensation at a sufficiently elevated temperature. Examples of such aldehydes are formaldehyde, glyoxal, glutaraldehyde and furfural.

According to a preferred embodiment, the aldehyde is a compound containing a hydroxymethyl or methylol group, such as formaldehyde.

According to another preferred embodiment, the aldehyde is dialdehyde, especially glyoxal. In one embodiment, a preferred amount of glyoxal used in the reaction is 25 to 50 mol-% of functional groups in lignin, more specifically uncondensed guaiacyl groups of lignin and p-hydroxyphenyl groups. In principle, 50% aldehyde reaction with functional groups enables an equimolar number of unreacted functional groups to aldehyde (or methylol groups in the case with formaldehyde) for cross-linking of the spherical colloidal lignin particles. As glyoxal can in principle react even with four phenolic groups, according to one embodiment the ratio of glyoxal to lignin could be as low as 25 mol-% of the functional groups.

According to a preferred embodiment glyoxal is added to the lignin polymer structure in its hydrated and dimerized form. Preferably, glyoxal is reacted with lignin in organic solution media.

Preferably no added catalyst is required for the aldehyde functionalization, as the acidity of lignin is sufficient to catalyze the reaction. However, according to one embodiment, acid can be added into the solution to speed up the reaction.

According to one embodiment the reaction temperature of lignin and aldehyde is as high as possible, where no significant lignin self-condensation occurs, as determined by the quality of the CLPs made of the lignin solution and by the ability of the aldehyde to fully react with lignin. A preferred reaction temperature is such that all of the aldehyde reacts without undesirable side-reactions. According to one embodiment, for example in case of glyoxal, a suitable reaction temperature is at least 65° C. According to one embodiment, for example in the case of formaldehyde, a suitable reaction temperature is at least 50° C.

Once the functionalized lignin derivative is formed, the next step is to form colloidal lignin particles through a self-assembly of lignin in a mixture of water and at least two organic solvents. Thus, colloidal lignin particles are formed by precipitating lignin with water from its solvent mixture by adding an amount of water, i.e. by increasing the molar ratio of water-to-solvent, in a way that stable aqueous dispersion of colloidal lignin particles is achieved. Lignin solution can be added into water or water into the lignin solution. Preferably, the added water is vigorously mixed to ensure that after feeding of the lignin solution the ratio between water and solvent where colloidal lignin particles are stable is reached as fast as possible, thus preventing the aggregation of lignin.

In the case of functionalized organic lignin solution, colloidal lignin particles are directly formed, i.e. self-assembled, upon the addition of said solution into.

According to one embodiment, a continuous flow tubular reactor is used for the formation of uniform dispersion of colloidal lignin particles. Addition of lignin solution into water is performed in the reactor.

According to one embodiment, the lignin solution upon coming in contact with water begins to form colloidal lignin nanoparticles. After passing over the entire mixing length, a homogenous dispersion of colloidal nanoparticles is obtained. The mixing elements increase the residence time and create turbulence within the tubular reactor. This results in better mixing and less precipitation on the walls of the tubular reactor, leading to the formation of a more uniform colloidal dispersion at the outlet.

The tubular reactor offers a relatively large surface area to volume ratio, which results in enhanced heat and mass transfer. In comparison to a conventional mixing reactor, there is very little variation in the mixing rate, which results in higher homogeneity. Furthermore, using a tubular reactor offers greater flexibility and ease of control. With a continuous flow tubular flow tubular reactor, it is possible to obtain a stable homogeneous dispersion with smaller particle size in comparison to a beaker set-up where in the CLPs are produced batch wise.

According to an embodiment a batch reactor can be used for the formation of uniform dispersions of colloidal lignin particles.

In the case of functionalized alkaline lignin solution, water soluble lignin does not form CLPs but it will after it is neutralized. As the neutralized product is insoluble in water, the neutralization is conducted with an acidic mixture of organic solvents, into which the neutralized product dissolves. From this organic mixture the CLPs are formed, i.e. self-assembled, upon the addition of said solution into water.

According to one embodiment, CLPs self-assemble in the mixture of water and at least one, preferably two or more organic solvents when the concentration of water in the dispersion exceeds 50 wt.-%, in particular 65 wt.-%, preferably the concentration of water is above 75 wt.-%.

The organic solvents used for the colloid formation are the same as described above in relation to dissolving lignin in organic solution. Thus, examples of the organic solvents for the dissolution of lignin are any organic solvents miscible in water and capable of dissolving at least one type of lignin at concentrations of at least 5 wt. %, preferably at concentration of 10 wt. % or more, are tetrahydrofuran and others, such as ethanol, dimethyl sulfoxide, acetic acid and dioxane.

According to a preferred embodiment, the organic solution includes an organic solvent and a co-solvent. The ratio of solvent and co-solvent can be adjusted to maximize the concentration of colloidal lignin particles in the final dispersion.

According to one embodiment, the ratio of solvent and co-solvent is in the range of 1:3-3:1, preferably the ratio is about 1:1.

According to one embodiment, the organic solvent is cyclic ether, such as tetrahydrofuran.

The used co-solvent can be any solvent miscible in water and capable of suppressing aggregation of lignin colloids at high lignin concentrations. Short to medium chained alcohols are known to be efficient co-solvents in prior art. Specifically the use of ethanol is preferred due to its low price and safety. Methanol works efficiently as well and can easily be recovered. Examples of other such solvents are n-propanol, isopropanol, n-butanol, isobutanol and tert-butanol.

According to preferred embodiment, the co-solvent is short to medium chained alcohol, i.e. selected from the group of alcohols containing 1 to 10, in particular 1 to 6, for example 1 to 4 carbon atoms. Such alcohols are for example ethanol and methanol.

According to one embodiment CLPs self-assemble in the mixture of water and two organic solvent (organic solvent and co-solvent), wherein the dispersion comprises in weight ratio of 13:11:76 first organic solvent, co-solvent and water, preferably THF, ethanol and water.

In preferred embodiment, the mixture of organic solvents consists of tetrahydrofuran together with ethanol or methanol or together with a combination of ethanol and methanol.

Numerous other variations and modifications in the invention as illustrated in the specific examples will be apparent to those skilled in the art, and hence it is not intended that the invention be limited to the examples but only as required by the spirit and scope of the appended claims.

According to one embodiment, after the formation of the colloidal lignin particles part of the organic solvents are recovered. Organic solvents are partially removed to condense the particles in the dispersion. The partial recovery of organic solvents can be accomplished by evaporation or pervaporation. When organic solvents are collected with evaporation, the colloidal lignin particles do not affect the evaporation conditions in any significant manner over the evaporation of a mixture of water and organic solvents. Thus, the desired amount of solvents can be collected with the means known to the art, with the fraction of water collected with the organic solvent being dependent on the pressure of the evaporation.

According to one embodiment, in small scale evaporation can be performed by rotary evaporation but in industrial scale other methods, such as distillation, flash evaporation and falling film evaporation, are usually employed.

The idea removing only part of the organic solvent is that presence of organic solvent in the next step of curing the colloidal lignin particles enables these colloids to remain internally homogeneous during curing, wherein a proper cross-linking or rearrangement of the particles is obtained. Organic solvent, preferably ethanol, enables CLPs to be sufficiently swollen to enable optimal cross-linking reactions or rearrangement between the colloidal lignin particles.

When the solvent content is too high, the lignin molecules within the CLPs are spaced so far apart, that cross-linking reactions take place at a low frequency, thus slowing the reaction down. Further, excessively high solvent content increases the average particle size. Similarly, if the solvent content is too low, the lignin molecules are too close to each other to prevent the mobility of the functional groups to encounter each other, thus again slowing the reaction down. Whereas, as already presented, no solvent content would require much higher curing temperatures and addition of catalyst, after which pH and solvent stable lignin colloids would not still be obtained.

Thus, according to a preferred embodiment the organic solvent acts as a reaction solvent and likely increases the mobility of the lignin particles by solvating the polymers to the point of enabling cross-linking reactions or rearrangement between lignin chains.

Thus, according to a preferred embodiment, at least ethanol is remained in the dispersion after evaporation. According to one embodiment, after the evaporation, the dispersion preferably comprises organic solvent or organic solvents at a content of 60 wt.-% in proportion to the weight of the spherical lignin colloid particles.

According to one embodiment the ratio of organic solvent of the total volume (including water) is above 10 vol. % but less than 25 vol. %.

According to one embodiment the partial solvent recovery comprises recovering 5 to 30 wt. %, preferably 10 to 25 wt. %, of the organic solvents calculated from the mass of the dispersion obtained by self-assembly of CLPs.

According to one embodiment, the dispersion obtained after partial solvent recovery comprises 13.7 wt. % organic solvent, preferably 4.3 wt. % THF and 10.2 wt. % ethanol.

According to one embodiment, the dispersion obtained after partial solvent recovery has a water to organic solvents ratio of 3:1, preferably in the range of 95:5 to 80:20.

According to a preferred embodiment the evaporation is performed at a temperature of 300 to 90° C. The choice of temperature is based on the highest temperature possible to prevent particle degradation from organic solvent, preferably ethanol, ebullition. Ethanol content within the particles behaves as a solvent for the cross-linking reaction. Thus, according to a preferred embodiment, the evaporation is performed at a temperature below 76° C., more preferably at 40° C. or below, for example at a temperature between 30 and 40° C.

According to one embodiment the average particle sixe after evaporation is between 400 and 480 nm.

Thus, to prevent the formation of structural heterogeneities in lignin particles, the control of the temperature and ethanol concentration is critical. Preferably, presence of organic solution during curing at sufficiently high temperature enables rearrangement of lignin particles, wherein lignin nanotubes can arrange with each other to a more compact form.

According to one embodiment the average particle size of the colloidal lignin particles after curing is less than 400 nm, preferably 320 to 400 nm, for example 395 nm.

Finally, the obtained CLPs are cross-linked with each other, i.e. cured, in order to form a stable colloidal lignin dispersion.

According to one embodiment, CLPs are heat-cured at elevated temperature upon gradual increase of pH.

In a preferred embodiment the functionalized, solvent-embedded, CLPs are heat-cured by simmering the aqueous dispersion in a bath of the solvent mixture.

According to one embodiment, the evaporation is performed at a temperature between 69 and 76° C.

According to a preferred embodiment the heat-curing is performed at a temperature of 73 to 76° C. (at atmospheric pressure), for example at 74° C. or at 76° C. due to the boiling point of ethanol.

According to one embodiment, the dispersion is heat-cured until the particles are stable, i.e. preferably at least until the pH of the dispersion is at least 11, preferably at least 11.5, more preferably 11.6.

pH stability is defined as a state, where the CLP dispersion produces a good signal by dynamic light scattering (DLS) measurement, when pH is adjusted to 11.6. This definition is chosen, as at this pH almost all of the phenolic groups of lignin are dissociated and if the CLP is not cross-linked, the CLPs loose their spherical shape, either due to full dissolution in the case of not at all cross-linked CLP, or are misshapen in the case of partially cross-linked CLP, as determined by various microscopic techniques, such as transmission electron microscopy (TEM). Beyond pH ca 11.6 the use of DLS to determine CLP stability is not fully reliable and microscopic techniques are preferred, as shown in FIG. 4. Partially stable CLPs can produce good DLS signal at a pH less than 11.6, but break apart when the pH of the dispersion is raised to 11.6. Partial stability can be envisioned to be desirable in applications where the pH of the application is below 11.6 and increased reactivity between the CLPs and the material with which it is to be reacted with is desirable. This is due the higher density of unreacted functional groups in the partially stable CLPs. Depending on the application the CLPs can even be fully unreacted, if the conditions in the application enable cross-linking without pH adjustment, such as adhesive applications, where the cross-linking time and temperature match those that produce a sufficient degree of cross-linking when conducted as a solvent containing aqueous dispersion

According to one embodiment, it is possible to adjust the pH of the dispersion prior to or during curing to increase the speed of the cross-linking reaction, i.e. the particles can be cured in the presence of base-catalysis through a controlled addition of base. However, the mode and rate of addition of the catalyst are critically important for the proper infusion of a base into the particles without their degradation or morphological changes, with particular consideration to solvent removed particles. For example, when using purified kraft lignin, with a low sodium content, the pH of the CLP dispersion is ca. 3 and the reaction progresses slowly, with stability at pH 11 reached in below 2 h, but not progressing to stability at pH 11.6 even overnight. When the pH of the dispersion is adjusted to 6 or slightly above, the speed of the cross-linking reaction is at a maximum, with stability at pH 11.6 obtained overnight, when cross-linked with 6 wt. % THF and 5 wt. % ethanol and at 76° C. The stability in this case is defined as producing good quality data by dynamic light scattering (DLS) and showing spherical particles remaining by transmission electron microscopy.

After curing, the CLPs remain intact at basic conditions (at least pH 10, or above), where they can be used as wood adhesives. Additionally these cured CLPs can be considered for any application where pH and solvent stability are required. Since once cured, the particles should be able to sustain high alkalinity, resist dissolution in organic solvents, and retain its morphological integrity at extreme conditions.

Methods steps for partial removal of the organic solution and curing the CLPs according to exemplary embodiments of the present invention can be seen in FIGS. 5a and b. Figure a presents uncatalyzed curing and FIG. 6 catalyzed curing.

According to one embodiment the obtained cured dispersion of aldehyde functionalized colloidal lignin particles is further activated with phenol-formaldehyde resin, wherein the ratio of lignin solids to phenol-formaldehyde solids is at least 8:1, preferably at least 9:1.

According to one embodiment the obtained cured dispersion of aldehyde functionalized colloidal lignin particles is further activated with base, such as sodium hydroxide, producing a pH 8 or less, preferably pH 7 or less.

The present invention also concerns a dispersion obtained by the present method, i.e. an aqueous dispersion of aldehyde functionalized spherical colloidal lignin particles.

According to a preferred embodiment the spherical colloidal lignin particles are internally homogeneous and fully cross-linked.

According to one embodiment, the dispersion is obtained by cross-linking the functionalized colloidal lignin particles by heat-curing the dispersion at a temperature between 73 to 76° C. in the presence of at least one organic solvent.

According to one embodiment, the dispersion comprises organic solvent or organic solvents at a content of 60 wt.-% in proportion to the weight of the spherical lignin colloid particles. According to one embodiment at most 90 vol. % of the solvents is water.

According to one embodiment the organic solvents have a lower boiling point than water and, wherein the organic solvents include at least one organic solvent which is miscible in water and capable of dissolving lignin at concentrations of at least 5 wt. %, preferably at concentration of 10 wt. % or more, and at least one co-solvent, said co-solvent which is miscible in water and preferably capable of suppressing aggregation of lignin colloids.

Preferably, the mixture of organic solvents consists of cyclic ether and an alcohol containing 1 to 4 carbon atoms, in particular the mixture of organic solvents consists of tetrahydrofuran together with ethanol or methanol or together with a combination of ethanol and methanol, preferably organic solvents comprise a mixture of tetrahydrofuran and ethanol.

Preferably, lignin is functionalized with formaldehyde or glyoxal.

The size of the colloidal lignin particles can vary and is dependent for example on the degree of interactions in the dispersion and concentration of lignin in dispersion. According to one embodiment the colloidal lignin particles have an average diameter between 300-500 nm, preferably 320-395 nm, measured by dynamic light scattering by using a Malvern Zetasizer Nano.

According to one embodiment the ratio of water to the solvents in the dispersion is at least 1:1, preferably in the range of 3:2-7:1.

According to one embodiment, the amount of colloidal lignin particles in a stable dispersion is at least 1.0 wt. %, preferably at least 1.5 wt. %, more preferably at least 2.0 wt. %, such as 2.5 wt. % or 2.8 wt. %.

According to one embodiment, the colloidal lignin particles can be dried from the dispersion. The drying of the colloidal lignin particles can be accomplished by any means known to the art, specifically, but not limited to, spray drying. In spray drying the concentrated aqueous colloidal lignin particles are fed into the spray dryer. In this embodiment a nebulizer produces a fine mist of colloidal lignin particles into a stream of hot air, at 180 degrees C. The hot air evaporates the water from the particle, producing a stream of dry lignin particles and stream of steam.

Furthermore, the heat of steam can be reused in the process, specifically in, but not limited to the recovery of solvents. The means to accomplish this are well known to those familiar with the art.

One embodiment provide a stable aqueous colloidal lignin particle dispersion concentrate, which exhibits a concentration lignin in the form of colloidal lignin particles of at least 10 wt. %, preferably 12 to 50 wt. %.

Another embodiment comprises removing from an aqueous dispersion of the above discussed kind a concentrate by removing at least a part, preferably at least 10% by weight, typically about 12 to 80% by weight of the water present in the aqueous dispersion.

Most types of lignin contain a fraction of ash, in particular inorganic ash and carbohydrates and similar non-soluble matter. The removal of ash is possible, but not required, for this embodiment. When lignin is dissolved in organic solvents, specifically, but not limited to THF, the inorganic ash precipitates. The means to remove the precipitate from the dissolved lignin are well known to those familiar with the art. In this embodiment the dissolved lignin is separated from the ash by decanting the solution from one vessel to another.

Furthermore, the reuse of the aqueous phase is possible, but not required, for this embodiment. In the case where the colloidal lignin particles need to be recovered either in a diluted or a concentrated dispersion, more water can be added to the process to account for the water going into the colloidal lignin dispersion.

Additionally, the full reuse of organic solvents is possible, but not enquired, for this embodiment. The addition of more solvent into the process can be accomplished, if this is economically more feasible than the full recovery of organic solvents.

Furthermore other means of separating the colloidal lignin particles from the aqueous phase other than the ones stated above can be used. The means for this are well known to those familiar with the art. Methods for this are specifically, but not limited to, the precipitation by the increase of the salt content or the alteration of the pH of the dispersion.

The applications in which the colloidal lignin particles and the dried lignin particles can be used for include, but are not limited to, Pickering emulsions, composites, antibacterial formulations, adhesives, binders, coatings, flocculants, drug delivery, food processing and cosmetics.

An embodiment of an application with concentrated colloidal lignin particles is a Pickering emulsion. A “Pickering emulsion” is an emulsion stabilized by solid particles which adsorb onto the interface between two phases. When an aqueous dispersion of colloidal lignin particles were vortex mixed with 1:1 volume ratio of rapeseed oil an emulsion formed at concentrations as low as 0.1 wt. % colloidal lignin particles. An increase of the colloidal lignin particle concentration increased the stability of the emulsion.

One embodiment comprises modification by adsorption of cationic polymer or cationic lignin to provide amphiphilic particles to improve efficiency for Pickering emulsions.

According to a preferred embodiment, the method of the present invention can be utilized in manufacture of adhesives wherein at least part of the phenol is replaced with lignin.

According to one embodiment, in order to increase the reactivity of the CLP surface, the density of methylol groups has to be increased. For this, the CLPs can be further reacted with phenol-formaldehyde (PF) resin to create a relatively thin reactive layer. As PF resin is much more reactive than the CLPs, the reaction of CLPs and PF in acidic media would just condense the PF resin, without it reacting with CLPs. Thus, the pH of the CLPs need to be raised to a pH of ca. 10 where the condensation reaction with CLP takes place in a controlled manner. These particles are first activated either with a reaction with phenol in acidic pH, or with sodium phenolate in basic pH, after which they can be grafted with commercial PF resin.

As the CLPs are relatively large, the thin layer of PF resin will be minimal in terms of adhesive mass. However, as the CLPs are already cross-linked, the only reaction required for the adhesive to work is the interparticle cross-linking of the CLPs, aided by the PF surface.

CLPs can be dense upon self-assembly and as such are not very compressible. However, upon an increase of pH, the CLPs can be swollen. The swollen particles can be more readily compressed, creating a fused honeycomb structure, which upon curing generates a fully interconnected polymer network.

Thus, according to an embodiment, in order to manufacture above described adhesives lignin is functionalized before or after (or both) the colloid formation.

### EXAMPLES

### Example 1

Dissolving Lignin in Alkaline Solution:

431 g of softwood Kraft lignin (with 68.1 wt. % solid content) was basified with 48.53 g of NaOH and diluted to 1104.78 g with deionized water and stirred until a homogenous solution is obtained.

Functionalization of Lignin with Aldehyde:

97.73 g of the above alkaline lignin solution was further basified by 1.70 g of NaOH and 2.06 g of 37 wt. % formaldehyde solution was added. The mixture was heated at 50° C. bath for 94 minutes and at 35° C. bath for two days to allow for the formaldehyde to fully react with lignin. 971 g of deionized water was added to dilute the solution and 11.08 g of 37 wt. % HCl was added to neutralize the solution. The dispersion was further diluted to 1159 g and sedimented by centrifugation (4350 rpm for 57 minutes). 854 g of the supernatant was recovered and 854 g of deionized water was poured onto the pellet to allow for the salt in the pellet to be diffused into the water phase. After 147 min. 856 of the aqueous phase was collected. The same was replicated with 855 g more of deionized water overnight, with the pH of the 866 g of the collected water phase being 3.17 and its conductivity being 1.90 mS/cm. The aqueous pellet containing the methylolated lignin is collected for further use.

Colloidal Lignin Particle Formation:

145 g of the above aqueous methylolated lignin is mixed with 150 of THF and sonicated to dissolve, after which 50.01 g of such organic methylolated lignin solution is inserted into 50.97 g of dionized water under stirring to form aqueous CLPs.

Crosslinking of Colloidal Lignin Particles:

First, 6.26 g of ethanol is added to the dispersion and solvents removed from the dispersion by rotary evaporating at 40° C., until a pressure of 35 mbar is obtained and the mass of the dispersion is reduced to 72.23 g.

Into 31.68 g of such aqueous methylolated CLPs (pH 3.84) in a round bottom flask is added first 403 μl of diluted phenol formaldehyde resin (Preferred Resins 14J025, 1:3 w:w ratio dilution with deionized water), with pH rising to 5.85 and second 1900 μl of 0.1 M NaOH, with pH rising to 7.03. The dispersion is stirred in a 100° C. oil bath overnight to yield a dispersion with pH 5.91. When the pH of this dispersion (500 μl aliquot) is raised to 11.72, the dispersion remains stable, as is seen by TEM (FIG. 4)

### Example 2

Functionalization of Lignin with Aldehyde:

6.00 g of dry kraft lignin (UPM PioPiva) is dissolved in a mixture of 6.03 g deionized water, 9.00 g of tetrahydrofuran and 39.34 g of ethanol. 435 μl of 40 wt. % glyoxal is added into the solution upon stirring and heated up to 65° C. in a 84° C. oil bath for 21 minutes.

Colloidal Lignin Particle Formation:

After the reaction the above solution is inserted into 157.70 g of stirred deionized water at 55° C., causing the glyoxylated lignin in the solution to form aqueous CLPs.

Crosslinking of Colloidal Lignin Particles:

212.79 g of the dispersion is rotary evaporated at 30° C. for 15 min to yield 183.76 g of the dispersion with reduced organic solvent concentration.

Option 1: 4.98 g of glyoxylated CLPs, with solvent partially removed is dispersed in a mixture of 12.9 ml of water and 2.1 ml of ethanol. The dispersion is heated in an oil bath at 87° C., so that the dispersion temperature reaches 74° C. The dispersion is heated overnight to yield a dispersion that is stable at pH 11.6.

Option 2: 5.04 g of glyoxylated CLPs, with solvent partially removed (Example 9) is dispersed in a mixture of 12.6 ml of water and 1.2 ml of ethanol and 1.2 ml of THF. The dispersion is heated in an oil bath at 87° C., so that the dispersion temperature reaches 76° C. The dispersion is heated for 3 h at its original pH of 3.6 after, which pH is raised to 6.3 by injection of 0.1 M NaOH, with 6 v % EtOH and 6 v % THF, with a syringe pump. The dispersion is heated overnight to yield a dispersion that is stable at pH 11.6, as determined by DLS.

### Example 3

Functionalization of Lignin with Aldehyde:

6.03 g of dry kraft lignin (UPM PioPiva) is dissolved in a mixture of 6.04 g deionized water, 26.02 g of tetrahydrofuran and 22.06 of ethanol. 435 μl of 40 wt. % glyoxal is added into the solution upon stirring and heated up to 65° C. in a 87° C. oil bath for 19 minutes.

Colloidal Lignin Particle Formation:

After the reaction the solution is inserted into 157.79 g of stirred deionized water at 56° C., causing the glyoxylated lignin in the solution to form aqueous CLPs.

Crosslinking of Colloidal Lignin Particles:

213.79 g of the dispersion is rotary evaporated at 30° C. for in four stages of 2 min, with 10 ml aliquots taken after each stage of the evaporation. The final pressure reached in the evaporation is 50 mbar and the final mass of the dispersion is 146.56 g, corresponding to a 13.7% reduction in mass of the dispersion, when taking account of the aliquots removed from the dispersion.

8.36 g of glyoxylated CLPs, with solvent partially removed (from Example 12) is heated in an oil bath at 87° C., so that the dispersion temperature settles at 72° C. and heated overnight. Thereafter the bath temperature is raised to 100° C. and the solvents let evaporate. After 80 minutes in a 100° C. bath, the dispersion temperature is at 76° C. and the dispersion stable at pH 11.75, as determined by DLS.

### Example 4

Dissolving Lignin in Alkaline Solution:

489 g of softwood Kraft lignin (with 68.1 wt. % solid content) is basified with 57.49 NaOH after dilution with 203 g of deionized water and 119 g of ethanol and stirred until a homogenous solution is obtained.

Functionalization of Lignin with Aldehyde:

728 g of the above alkaline lignin solution is diluted with 122 g of ethanol and 64.25 g of such solution is reacted with 1.57 g of 37 wt. % formaldehyde solution at 50° C. for 5 h.

10.06 g of the methylolated alkaline lignin solution is neutralized by adding a mixture of 1.30 g of 37 wt. % HCl, 7.11 g ethanol and 13.74 g of THF under stirring. The NaCl formed in the neutralization and the insoluble residue present in the used lignin are separated from the solution by centrifugation and the supernatant used in further Examples.

Colloidal Lignin Particle Formation:

11.24 g of the methylolated organic lignin solution is inserted into 30.02 g of deionized water to form CLPs. After rotary evaporation at 50° C. down to the pressure of 48 mbar, 23.17 g of pH 3.91 methylolated CLP are collected.

The Following Embodiments are Preferred:

1. Aldehyde functionalization of an alkaline solution of lignin by low temperature reaction, at 50° C., yielding a solution with minimal lignin to lignin condensation. The aldehyde is any aldehyde which is still reactive after the initial reaction with lignin. More specifically such aldehydes are formaldehyde and dialdehydes, such as glyoxal and glutaraldehyde.

2. Neutralized aqueous dispersion of aldehyde functionalization lignin from claim 1 by acid washing.

3. Organic solution of aldehyde functionalization lignin from claim 1 by neutralization with acidic organic solution.

4. Organic solution of aldehyde functionalization lignin from claim 2 by dissolution with organic solvents.

5. Aldehyde functionalization of an organic solution of lignin by low temperature reaction, at 65° C., yielding a solution with minimal lignin to lignin condensation.

6. An aqueous aldehyde functionalized colloidal lignin particle dispersion prepared from solutions according to claims 3 to 5 with the solvents remaining in the prepared dispersion.

7. A dispersion according to claim 6, with organic solvents partially recovered, wherein the ratio of water to solvents is 3:1, preferably in the range of 95:5 to 80:20.

7.2. A method according to claims 6 to 7, where the aqueous colloidal lignin particle dispersion, with remaining organic solvents is functionalized with another reagent suitable for cross-linking the colloidal lignin particles.

8. A method of inducing the cross-linking the dispersion of aqueous aldehyde functionalized colloidal lignin particle according to claim 7 by the heating of the dispersion at a temperature above 65°

9. A method of improving the efficiency of cross-linking according to claim 8 by the concurrent evaporation of organic solvents of said dispersion.

10. A method according to claims 8 to 9, where the dispersion of the aldehyde functionalized colloidal lignin particles is activated with phenol-formaldehyde resin, wherein the ratio of lignin solids to phenol-formaldehyde solids is at least 8:1, preferably over 9:1.

11. A method according to claims 8 to 10, where the dispersion of the aldehyde functionalized colloidal lignin particles is activated with base, such as sodium hydroxide, producing a pH at maximum of 8, preferably below 7.5

12. A method according to claims 8 to 11, where the cross-linked particles are reacted until they are stable, or retain their spherical shape, at alkaline pH. In particular at pH above 10, preferably pH above 11.5

### INDUSTRIAL APPLICABILITY

The present technology can be applied to produce functionalized colloidal lignin particles, especially stable functionalized colloidal lignin particle dispersions, in particular solvent and pH stable functionalized colloidal lignin particles. Applications of functionalized solvent-embedded CLPs, both cross-linked and non-cross-linked, are not limited to adhesives and wood treatment, but comprise any application where the ability of enabling cross-linking reactions between the lignin molecules is beneficial. Examples of such applications include, but are not limited to, composites, coatings, binders, cosmetics, Pickering emulsions, antibacterial formulations, flocculants, drug delivery and food processing.

### CITATION LIST

### Patent Literature

WO2015/089456
WO 2018/011668

1. An aqueous dispersion of aldehyde-functionalized spherical colloidal lignin particles, wherein the spherical colloidal lignin particles are internally homogeneous and cross-linked.

2. The dispersion according to claim 1, wherein the spherical colloidal lignin particles are cross-linked by heat-curing the dispersion at a temperature between 73 to 76° C. in the presence of at least one organic solvent.

3. The dispersion according to claim 1, wherein the dispersion comprises one or more organic solvents at a content of 60 wt.-% in proportion to the weight of the spherical lignin colloid particles.

4. The dispersion according to claim 3, wherein the one or more organic solvents have a lower boiling point than water, and wherein the one or more organic solvents include at least one organic solvent which is miscible in water and capable of dissolving lignin at concentrations of at least 5 wt. % and at least one co-solvent, said co-solvent being miscible in water and capable of suppressing aggregation of lignin colloids.

5. The dispersion according to claim 3, wherein the one or more organic solvents comprise a cyclic ether and an alcohol containing 1 to 4 carbon atoms.

6. The dispersion according to claim 1, wherein the aldehyde of the aldehyde-functionalized spherical colloidal lignin particles is formaldehyde or glyoxal.

7. The dispersion according to claim 1, wherein the spherical colloidal lignin particles have an average diameter between 320 to 395 nm, measured by Light Scattering technique by Malvern Zetasizer Nano.

8. The dispersion according to claim 3, wherein a ratio of water to the one or more organic solvents is in the range of 3:2-7:1.

9. The dispersion according to claim 1, wherein the spherical colloidal lignin particles are further interleaved with each other.

10. A method for forming an aqueous dispersion of aldehyde-functionalized spherical colloidal lignin particles, the method comprising the steps of:
providing lignin in a dissolved form,
functionalizing the lignin by reacting it with aldehyde,
providing the functionalized lignin in a mixture with water and one or more organic solvents to form the aqueous dispersion of aldehyde-functionalized spherical colloidal lignin particles,
partially removing the one or more organic solvents from the dispersion, and
heat-curing the dispersion until the particles are stable.

11. The method according to claim 10, wherein the lignin is obtained from a lignocellulosic raw-material by dissolution in an alkaline medium or in an organic medium.

12. The method according to claim 10, wherein the lignin is provided in a dissolved form by dissolving lignin into an alkaline aqueous solution or into an organic solution.

13. The method according to claim 10, wherein the dissolved lignin is functionalized with formaldehyde or glyoxal.

14. The method according to claim 10, wherein the concentration of water in the dispersion of spherical colloidal lignin particles is more than 50 wt. %.

15. The method according to claim 10, wherein the one or more organic solvents include at least one organic solvent which is miscible in water and capable of dissolving lignin at concentrations of at least 5 wt. % and at least one co-solvent, said co-solvent being miscible in water and capable of suppressing aggregation of lignin colloids.

16. The method according to claim 10, wherein the partial removal of the one or more organic solvents from the dispersion is performed by evaporation at a maximum dispersion temperature of 40° C., and wherein the dispersion comprises the one or more organic solvents at a content of 60% in proportion to the weight of the spherical lignin colloid particles.

17. The method according to claim 10, wherein the dispersion is heat-cured at a temperature of 73-76° C. to cross-link the colloidal lignin particles.

18. The method according to claim 10, wherein the spherical colloidal lignin particles are dried by spray drying.

19. The method according to claim 10, further comprising forming an adhesive from the spherical colloidal lignin particles are used to prepare adhesives.

20. The dispersion according to claim 5, wherein the one or more organic solvents comprise tetrahydrofuran together with ethanol and/or methanol.
